(19) United States
(12) Patent Application Publication
(10) Pub. No.: US 2026/0258287 A1
(43) Pub. Date: Sep. 3, 2026

(54) DEBONDABLE ADHESIVE

(71) Applicant: D-GLUE CORP., Leominster, MA (US)

(72) Inventors: Kristoffer K. STOKES, Lunenburg, MA (US); Philip J. COSTANZO, San Luis Obispo, CA (US)

(21) Appl. No.: 19/655,166

(22) Filed: Apr. 22, 2026

Related U.S. Application Data
(63) Continuation of application No. PCT/US2024/052182, filed on Oct. 21, 2024.
(60) Provisional application No. 63/592,412, filed on Oct. 23, 2023.

(51) Int. Cl. C09J 145/00; C08F 222/40; C08F 232/06; C08F 232/08; C08F 234/02; C08F 279/02; C09J 7/30; C09J 135/00; C09J 151/04

(52) U.S. Cl. CPC C09J 145/00; C08F 222/406; C08F 232/06; C08F 232/08; C08F 234/02; C08F 279/02; C09J 7/30; C09J 135/00; C09J 151/04; C09J 2203/37

(57) ABSTRACT

A debondable adhesive formulation including a multifunctional polymer with programmable linkages formed from Diels-Alder adducts, a concentration of diene traps, and non-programmable linkages that do not dissociate at a debondable temperature is described. The programmable linkages include one or more diene-dienophile pairs that form the Diels-Alder adducts. The diene traps are (i) latent alkenes or (ii) functional groups that react with the one or more dienes to form diene-diene trap adducts stable until dissociated at the debondable temperature, where moles of the diene traps exceed moles of the one or more dienes. The formulation can be applied as a coating and extruded, with a bonding temperature between 30° C. and 150° C. and a debondable temperature at or above 130° C. At or above the debondable temperature, at least a portion of the programmable linkages, the diene-diene trap adducts, or both dissociate, reducing adhesive bonding force.

### CROSS-REFERENCE TO RELATED APPLICATIONS

This application is a continuation of International Patent Application No. PCT/US2024/052182, entitled “DEBONDABLE ADHESIVE”, filed on Oct. 21, 2024, which claims priority to U.S. Provisional Patent Application No. 63/592,412, entitled “DEBONDABLE ADHESIVE”, filed on Oct. 23, 2023, the entire contents of all of which are incorporated herein by reference.

### BACKGROUND OF THE INVENTION

Adhesives are widely used to fasten materials together in manufacturing settings. Adhesives that can be applied to a large area with ease result in reduced labor costs and durable connections. Different categories of polymers have been used to create adhesive systems. Epoxies, silicones, modified silicones, acrylics, cellulosics, vinyl esters, polyureas, polyurethanes, and phenol nitrile systems, among others are some of the basic resin systems used in adhesive formulation. Selection of a base material system is often decided based on the performance requirements and substrates to be adhered. However, the problem with existing adhesive systems is that they cannot be readily defeated or debonded at the end of the product lifetime, thus preventing reuse of valuable product components.

Thus, there exists a need to create adhesives that can be applied easily for manufacturing purposes, are durable during the lifetime of the product, and can be readily defeated or debonded using a selected stimulus at the end of usable life. This approach enables reuse and recovery of high value components within the product. Furthermore, it can enable simpler rework and repair of durable consumer goods, leading to cost savings for manufacturers. The present invention provides such debondable adhesives.

### SUMMARY OF THE DISCLOSURE

In a first aspect of the invention, a debondable adhesive formulation comprises a multifunctional polymer having programmable linkages made from Diels-Alder adducts and a concentration of diene traps. The programmable linkages comprise one or more diene-dienophile pairs capable of forming the Diels-Alder adducts. The diene traps are (i) latent alkenes or (ii) selected from functional groups that will react with the one or more dienes to create diene-diene trap adducts that remain stable until dissociated at a debondable temperature of the adhesive, wherein moles of the diene trap exceed moles of the one or more dienes. The debondable adhesive formulation is capable of being applied as a coating. The debondable adhesive formulation is capable of being extruded. The debondable adhesive formulation has a bonding temperature between 30 degrees Celsius and 150 degrees Celsius, and a debondable temperature at or above 130 degrees Celsius. When the debondable adhesive formulation is at or above the debondable temperature, at least a portion of one or both the programmable linkages and the diene-diene trap adducts disassociate and an adhesive bonding force is reduced. The adhesive formulation includes non-programmable linkages that do not disassociate at the debondable temperature.

### BRIEF DESCRIPTION OF THE DRAWINGS

The foregoing aspects and other features of the disclosure are explained in the following description, taken in connection with the accompanying drawings, wherein:

FIG. 1 is a schematic representation of an exemplary thermoset system. In FIG. 1, the term “p” represents the monomer conversion ratio. The term “p_{c}” represents the critical gelation conversion ratio where the network begins to form, but there is still sufficient long-range motion to have a workable material. Large spheres represent multifunctional polymers, oligomers, or molecules (functionality greater than or equal to 2.0). Small spheres represent difunctional polymers, oligomers, or molecules (functionality equal to 2.0). The large spheres have functionality that reacts with the small spheres, creating a covalent or dative bond that links the components together.

FIG. 2 is a schematic representation of the interconversion of Diels-Alder adducts as the temperature and cure state increase.

FIG. 3 is a graphical representation of the forward and reverse Diels-Alder reaction for each adduct. In FIG. 3, the overlay indicates temperature regions where processing, bonding, and debonding steps occur.

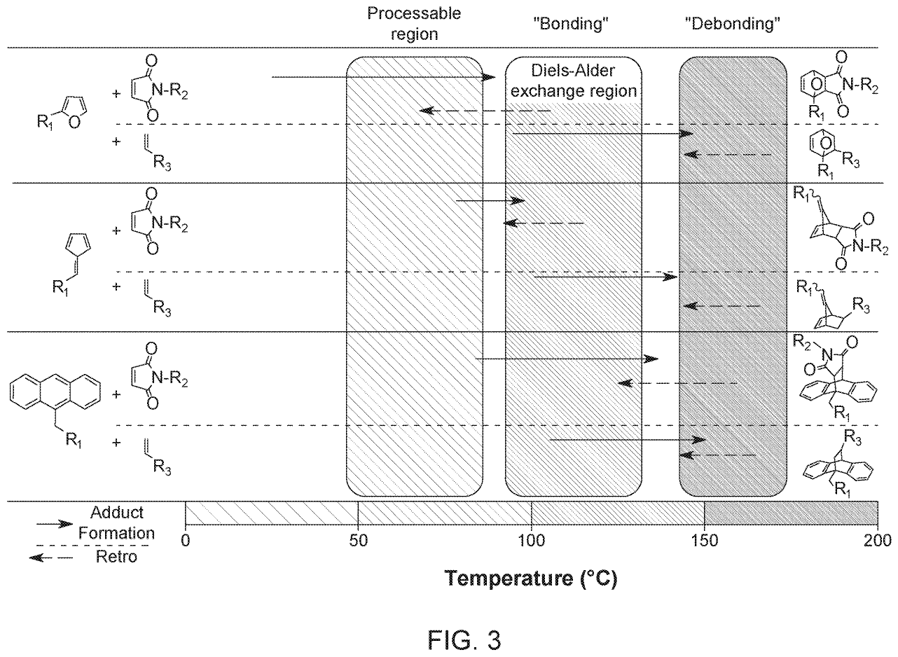

### DETAILED DESCRIPTION

To promote an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Unless otherwise indicated, technical and scientific terms used herein have the same meaning as commonly understood by those of ordinary skill in the art to which this disclosure belongs.

The use herein of the terms “including,” “comprising,” or “having,” and variations thereof, is meant to encompass the elements listed thereafter and equivalents thereof as well as additional elements. As used herein, “and/or” refers to and encompasses all possible combinations of one or more of the associated listed items, as well as the lack of combinations when interpreted in the alternative (“or”).

Furthermore, the indefinite articles “a” and “an” preceding an element or component of the invention are not intended to limit the number of occurrences of the element or component. Therefore, “a” and “an” should be understood to include one or at least one, and unless the number is explicitly singular, the singular form of the element or component also includes the plural form.

The present invention addresses the need for adhesives that can be selectively defeated at the end of life.

Programmable Linkages (PLs) are defined as chemical motifs with specific formation/cleavage conditions. These reactions have become increasingly popular methods for the preparation of materials due to their efficiency and ease of use. PLs impart thermally responsive behavior. Diels-Alder chemistry is a specific type of PL that has been studied extensively, and the chemical reaction mechanisms are well understood. In a Diels-Alder reaction, a dienophile and a diene undergo a [4+2] cycloaddition to form a six-membered ring. The electronic configurations of the diene and dienophile dictate the thermodynamic parameters for both the formation and cleavage of the ring structure. For temperature-induced retro Diels-Alder reactions, the diene is usually electron-rich, whereas the dienophile is electron-poor.

The furan/maleimide Diels-Alder system is one example that undergoes adduct formation at temperatures between room temperature (RT) and 90° C.; however, because this is an equilibrium reaction, the cycloreversion begins to occur at 60° C. and becomes the dominant reaction at 90° C. The anthracene/maleimide system is another example of a Diels-Alder system that has been shown to display adduct formation starting at 90° C. with its retro reaction becoming dominant at approximately 120° C. Reacting either the furan or anthracene with an alkene forms an adduct that does not display significant overlap between adduct formation and cycloreversion. Since these equilibrium reactions overlap, a Diels-Alder exchange can occur, where the dissociated adducts can reform in new combinations with other components that are present in the system. For example, the furan/maleimide adduct can exchange into an anthracene/maleimide adduct.

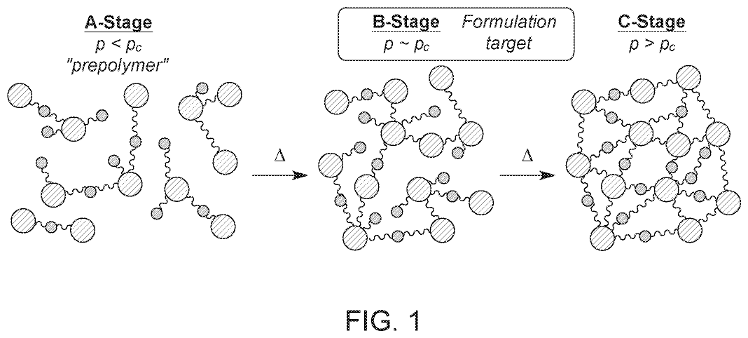

Creation of a defeatable (debondable) adhesive begins with the incorporation of Diels-Alder Programmable Linkages (PLs) into an adhesive polymer system. The terms “defeatable” and “debondable” are used interchangeably herein for the purposes of the specification and claims. The PLs can be incorporated into a range of different polymers providing the ability to tune the defeatable adhesive for a range of physical properties. In most adhesive formulations, the base polymer class dictates many of the properties such as mechanical strength, substrate compatibility, cure time, elastic recovery, creep behavior, among other properties known to those skilled in the art. Therefore, it is important to have a system that can be broadly applied to many adhesive systems in existence. A thermoset adhesive system is illustrated in FIG. 1. One example of FIG. 1 is using polyurethanes where the large spheres represent a polyol crosslinker and the small spheres represent a difunctional isocyanate. Alternatively, the reactive groups could be inverted. A different polyurethane system could use the large spheres as multifunctional isocyanates (more than 2 reactive groups) and the small spheres as a polymeric, oligomeric, or small molecule diol. An example of FIG. 1 with an epoxy system uses the large spheres as a multifunctional epoxy and the small spheres as a difunctional reactive group compatible with epoxy reactivity (this could include amines, polyfunctional acids, thiols, phenols, anhydrides and alcohols, among others). The system could also be inverted with the large spheres representing a multifunctional polymer, oligomer, or small molecule containing functionalities that react with epoxy groups (as described above), and the small spheres representing a difunctional epoxy polymer, oligomer, or small molecule. Another example is silane systems that can include multifunctional silicone materials with more than one end functional group (large spheres) that react with the difunctional polymers, oligomers, or small molecules (small spheres). The inverse is also applicable. Each of these systems can be combined with another as there exist modified silicones with polyurethane, epoxy, acrylic, and etc. functionality.

Here, the present inventors specifically design and formulate the balance of reversible Diels-Alder linkages and irreversible linkages incorporated into a polymer base to create an adhesive that can be durable for the lifetime of a product but can be weakened or defeated by exposure to a stimulus. In this case, the stimulus is heat. By creating formulations that specifically target the available reversible and irreversible reactions, the adhesion capability as well as the dehiscence behavior can be tailored.

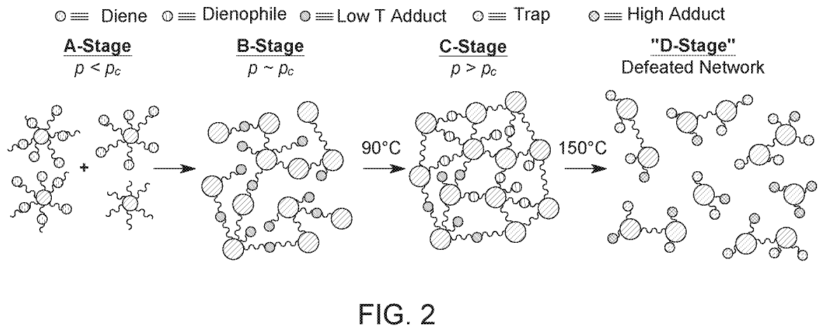

Regardless of the base adhesive system material employed for mechanical and compatibility reasons, thermal programmability is influenced by the balance of reversible and irreversible crosslinks. Formulations can be customized depending on the Diels-Alder systems and the concentration of dienophile employed. By combining these various Diels-Alder systems, the exchange between linkages is programable which dictates the balance of reversible and irreversible crosslinks. FIG. 2 is a schematic depicting interconversion of Diels-Alder adducts in a debondable adhesive formulation as the temperature and cure state increases. The figure is a representation of crosslinking that can occur using Diels-Alder programmable linkers in an adhesive formulation. The large spheres in the figure represent multifunctional polymers and the small circles are demonstrating one way that the programmable linkages can dissociate and exchange in the temperature ranges that induce cycloreversion. Much of the handling and application of the adhesive can be performed in the B-stage, where there is still mobility in the chains. Once the temperature gets to the “bonding” or curing range at C-stage, some of the reversible crosslinks have dissociated. At this point, while it is possible for the recently dissociated diene and dienophile to recombine, the presence of diene traps creates opportunities for combinations of the diene and the diene traps to create higher temperature adducts. These higher-temperature adducts will form in some proportion to the formulation in the bonding stage but can be reactivated (i.e., disassociated) by heating the system to an even higher temperature (outside of the normal environmental conditions the adhesive would see). Once at that higher temperature, there is dissociation of the diene-dienophile and diene-diene trap adducts and reconfiguration of the network that reduces the adhesive and cohesive forces keeping the adhesive and substrate together. FIG. 1 is a graphical representation of forward and reverse Diels-Alder reactions for each diene-dienophile and diene-diene trap adduct. The overlay indicates temperature regions where processing, bonding, and debonding steps for the adhesive occur.

In one aspect, this invention is directed towards adhering two substrates together with a debondable adhesive. The substrates can include synthetic or natural fibers, blends of synthetic or natural fibers, synthetic or natural fiber-based textiles, textiles comprised of synthetic or natural fibers, plastic films and sheets, molded plastic parts, paper, ceramics, glass, metals, or any combination thereof.

The composition of the formulation requires a programmable linkage comprised of a Diels-Alder adduct, selected as a combination of diene and dienophile. The diene can be selected from the list of modified furan, modified fulvene, modified anthracene, modified conjugated alkenes (such as butadiene and its derivatives), modified conjugated imines (known as an aza Diels-Alder type reaction). The dienophile functionality can be selected from a list of modified maleimide, modified alkene, modified alkyne, modified imide (known as imide Diels-Alder type reaction), modified aldehydes (known as an oxo-Diels-Alder type reaction), or modified ketones.

This programmable linkage can be installed in- or ex-situ on a multifunctional polymer, typically an oligomeric or polymeric polyol of functionality 2.0 or greater for network forming capabilities. Such materials can include a variety of polymer classes selected for adhesive properties. For example, these polymer classes include, but are not limited to, polyolefins (including polyethylene, polypropylene, poly-1-hexene, polymethylpentene), polyesters (including PET, PBAT, PBT, and variations thereof), polyethers (including polyoxymethylene, polyethylene glycol, polyethylene oxide, polypropylene oxide, polybutylene oxide, and polyphenylene ether), polystyrenes, polyhydroxyalkanoates, polyisoprenes, polybutadienes, polysiloxanes, polyimides, polyethersulfones, poly ether ether ketones, liquid crystal polymers, polyamides, polycarbonate, polyacrylates, and polyurethanes. Additional polyols that can be used include naturally derived polyols, such as carbohydrate-based materials-including starches, mono and polysaccharides, and derivatives of naturally occurring oils including soybean oil, rapeseed oil, castor oil, peanut oil, sunflower oil.

To obtain the desired defeatability and dehiscence behavior the full adhesive formulation must include an additional diene trap. A diene trap is herein defined as a dienophile that will react with and capture free dienes that have been liberated through a retro Diels-Alder reaction or were intentionally included in the adhesive formulation for desired properties. This mechanism provides the network cleavability that enables the desired adhesive failure upon application of a heat stimulus. Additionally, a preferred diene trap is selected from the previous list of dienophiles such that the adduct consisting of the available free diene and the diene trap does not undergo retro Diels-Alder at the temperature desired for defeatability. In the Examples provided herein below, the diene trap is the residual alkenes present on polybutadiene, both on the diene-dienophile modified, and base hydroxy-terminated polybutadiene. In other embodiments, the diene trap may be an additional small molecule, oligomer, or polymeric species specifically added to tune properties including adhesion, flow, mechanical strength, bonding temperature, debonding temperature, and application or process properties. Furthermore, these diene traps may be added as a small molecule additive within the formulation or can also be attached to a polymer within the formulation. These traps do not need to be the same and can be included as a mixture of different types of diene traps to further modify the debonding behavior.

The adhesive formulations of the present disclosure may include additional additives that do not interact specifically with the constituent diene, dienophile, or diene traps to add additional properties that improve processing, adhesion, flow, or aesthetic properties, as recognized by those skilled in the art. As a non-exhaustive list, some of these additives may include waxes, tackifiers, UV stabilizers, acid scavengers, radical scavengers, fillers, pigments, dyes, antistatic agents, and the like.

Herein, the dienophile is referred to as A, the diene as B, and the diene trap as AT. In some embodiments, the mole ratio of dienophile to diene, defined as A: B, has an excess of diene, for example, with a mole ratio of 0.10-0.75, 0.10-0.50, or 0.15-0.30. In some embodiments, the mole ratio of the diene trap to diene, defined as AT:B, has an excess of diene trap and has a mole ratio of 1-25 or 5-15.

As polymer networks can be assembled in a variety of manners, it is important to maintain the ratio of programmable linkages against the amount of non-programmable linkages. In the Examples herein below, the programmable linkages (PL) are the Diels-Alder adducts (specifically maleimide-furan, maleimide-fulvene, and maleimide-anthracene are exemplified), and non-programmable (N) are the additional isocyanate functional groups that provide network connectivity but cannot thermally disassociate. For a debondable system, the PL:N ratio can be 0.01-4, 0.1-1, or 0.5-0.9. While the examples described below demonstrate the concept with an isocyanate non-programmable linker, it could similarly be executed with other reactive systems such as epoxy, silanes (including acetoxy, oximino, and alkoxy), metals, carbodiimides, and the like.

In the Examples provided below, the adhesive formulations are solutions that can be coated on a substrate, such as a release liner, and treated as a hot melt adhesive film. In some embodiments, the adhesive formulations are referred to as “B-stage” thermoset materials. The temperature range for bonding the B-stage thermoset materials of the present invention is application dependent and debonding steps can take place at a temperature higher than the application temperature.

In one embodiment of the invention, a debondable adhesive formulation is provided that includes (i) a multifunctional polymer having programmable linkages made from Diels-Alder adducts and (ii) a concentration of diene traps. The programmable linkages include one or more diene-dienophile pairs capable of forming the Diels-Alder adducts. The diene traps are (i) latent alkenes or (ii) selected from functional groups that will react with the one or more dienes to create diene-diene trap adducts that remain stable until dissociated at a debondable temperature of the adhesive. In the debondable adhesive formulation, moles of the diene trap exceed moles of the one or more dienes. The debondable adhesive formulation is capable of being applied as a coating or extruded. The debondable adhesive formulation has a bonding temperature between 30 degrees Celsius and 150 degrees Celsius and the debondable temperature is at or above 130 degrees Celsius. When the debondable adhesive formulation is at or above the debondable temperature, at least a portion of one or both the programmable linkages and the diene-diene trap adducts disassociate and an adhesive bonding force is reduced. The adhesive formulation includes non-programmable linkages that do not disassociate at the defeatable temperature.

In another embodiment of the invention, a method is provided of forming a debondable adhesive, that includes forming a multifunctional crosslinkable polymer including a concentration of dienes, dienophiles, and diene traps. In the method, the diene and dienophile react to form a first Diels-Alder adduct. The diene trap is (i) a latent alkene or (ii) selected from functional groups that will react with the diene to create diene-diene trap adducts that remain stable until dissociated at a debondable temperature of the adhesive. Moles of the diene trap exceed moles of the diene. A presence of the diene-diene trap adduct is dominant at a bonding temperature of the adhesive. A retro Diels-Alder reaction of both the first and the second Diels-Alder adduct is dominant at a debondable temperature of the adhesive and an adhesive bonding force is reduced. The bonding temperature is between 30 degrees Celsius and 150 degrees Celsius. The debondable temperature is a temperature at or above 150 degrees Celsius, and the multifunctional crosslinkable polymer includes linkages that do not disassociate at the debondable temperature.

Additionally, the debondable adhesive materials of the present invention can be prepared in other forms. One such form is known in the art as a “2K” formula. Examples of this type of formulation include two-part polyurethanes, where the reactive portions (e.g., polyol and isocyanates) are kept separate until ready for use. Other examples include two-part epoxy-based and two-part silane-or silicone-based debondable adhesives. When the two-part debondable adhesives are ready for use, they are mixed, and the crosslinking reaction begins. The adhesive material can then be added to the substrates in a liquid manner, either manually or through an automated assembly line. The two parts do not necessarily need to be liquid in nature, as two-part systems exist that arrive as two liquids, two soft solids, or a liquid and a solid. The two-part debondable adhesives are capable of being applied as a coating or as a paint or applied with a syringe or other applicator.

In one aspect, a two-part adhesive formulation is provided that includes (i) a first formulation comprising a first polyol crosslinker having two or more reactive alcohol functionalities and including incorporated programmable linkages made from Diels-Alder adducts and (ii) a second formulation comprising the first polyol crosslinker, another polyol crosslinker capable of reacting with the first polyol functionalities, or a diisocyanate, and wherein one or both the first and the second formulation comprise a concentration of diene traps. The programmable linkages comprise one or more diene-dienophile pairs capable of forming the Diels-Alder adducts. The diene traps are (i) latent alkenes or (ii) selected from functional groups that will react with the one or more dienes to create diene-diene trap adducts that remain stable until dissociated at a debondable temperature. The moles of the diene trap exceed moles of the one or more dienes. After combination of the first and second formulations, the combined adhesive formulation has a bonding temperature between 30° C. and 150° C. The debondable temperature of the combined adhesive formulation is above 130° C., and when the combined adhesive formulation is at or above 130° C., at least a portion of one or both the programmable linkages and the diene-diene trap adducts disassociate and an adhesive bonding force is reduced. The combined adhesive formulation includes non-programmable linkages that do not disassociate at the debondable temperature. In another embodiment of this formulation, the Diels Alder linkages can be incorporated into the diisocyanate instead of the polyol crosslinker. For example, the first formulation can instead comprise the isocyanate having a reactive functionality of two or more, the isocyanate having the incorporated programmable linkages made from Diels-Alder adducts, and the first polyol crosslinker having two or more reactive alcohol functionalities; and (ii) the second formulation can instead comprise a polyol crosslinker having two or more reactive alcohol functionalities that does not necessarily have to include the Diels-Alder linkages.

In another aspect, a two-part adhesive formulation is provided that includes: (i) a first formulation comprising an epoxy-based crosslinker having a reactive functionality of two or more and having incorporated programmable linkages made from Diels-Alder adducts; and (ii) a second formulation comprising a polyol or polyamine having two or more reactive functionalities capable of reacting with the epoxy-based crosslinker. One or both the first and the second formulation comprise a concentration of diene traps. The programmable linkages comprise one or more diene-dienophile pairs capable of forming the Diels-Alder adducts. The diene traps are (i) latent alkenes or (ii) selected from functional groups that will react with the one or more dienes to create diene-diene trap adducts that remain stable until dissociated at a debondable temperature. Moles of the diene trap exceed moles of the one or more dienes. After combination of the first and second formulations, the combined adhesive formulation has a bonding temperature between 30° C. and 150° C. The debondable temperature of the combined adhesive formulation is above 130° C., and when the combined adhesive formulation is at or above 130° C., at least a portion of one or both the programmable linkages and the diene-diene trap adducts disassociate and an adhesive bonding force is reduced. The combined adhesive formulation includes non-programmable linkages that do not disassociate at the debondable temperature. In another embodiment of this formulation, the Diels Alder linkages can be incorporated into the polyol or polyamine crosslinker instead of the epoxy-based crosslinker. For example, the first formulation comprises the polyol or polyamine crosslinker having a reactive functionality of two or more and having incorporated programmable linkages made from Diels-Alder adducts; and (ii) the second formulation comprises the epoxy-based crosslinker having two or more reactive functionalities capable of reacting with the polyol or polyamine crosslinker.

In yet another embodiment, a two-part adhesive formulation is provided that includes: (i) a first formulation comprising a silane-based crosslinker having a reactive functionality of two or more and having incorporated programmable linkages made from Diels-Alder adducts; and (ii) a second formulation comprising a silane or silicone having two or more reactive functionalities capable of reacting with the silane-based crosslinker. One or both the first and the second formulations comprise a concentration of diene traps. The programmable linkages comprise one or more diene-dienophile pairs capable of forming the Diels-Alder adducts. The diene traps are (i) latent alkenes or (ii) selected from functional groups that will react with the one or more dienes to create diene-diene trap adducts that remain stable until dissociated at a debondable temperature. Moles of the diene trap exceed moles of the one or more dienes. After combination of the first and second formulations, the combined adhesive formulation has a bonding temperature between 30° C. and 150° C. The debondable temperature of the combined adhesive formulation is above 130° C., and when the combined adhesive formulation is at or above 130° C., at least a portion of one or both the programmable linkages and the diene-diene trap adducts disassociate and an adhesive bonding force is reduced. The combined adhesive formulation includes non-programmable linkages that do not disassociate at the debondable temperature.

One-part systems (also known as moisture cure or “1K”) systems can also be utilized as a base reaction system to incorporate the adhesive materials. Silicone adhesives and sealants are frequently used as a 1K moisture cure system, but other systems including polyurethanes have been used. By incorporating PLs inside one of these formulations, debondable sealants and encapsulants for industry, such as the construction, aviation, and electronics industry can be produced. In fact, vinyl containing silane is regularly used to improve filler compatibility, bonding strength, and to improve other formula properties, and can work well as a diene trap system according to the methods described herein.

In the methods and adhesive formulations described herein, the one or more diene-dienophile pairs can be selected from furan-maleimide, anthracene-maleimide, and fulvene-maleimide, and combinations thereof.

In one embodiment, the one or more diene-dienophile pairs of a debondable adhesive formulation provided herein include furan-maleimide, the bonding temperature ranges from 65-100° C., and the debondable temperature ranges from 110-160° C.

In another embodiment, the one or more diene-dienophile pairs of a debondable adhesive formulation provided herein include fulvene-maleimide, the bonding temperature ranges from 75-110° C., and the debondable temperature ranges from 120-160° C.

In yet another embodiment, the one or more diene-dienophile pairs of a debondable adhesive formulation provided herein include anthracene-maleimide, the bonding temperature ranges from 90-130° C., and the debondable temperature ranges from 130-160° C.

The adhesive materials of the present invention can be also prepared in a gluestick form. These gluesticks can be prepared through a solution casting method from a solvent, or as a neat molten material that is warmed to a temperature where the polymer system can be worked but has not yet fully cured and formed through an extrusion, injection molding, or casting methodology.

Properly formulated, the adhesive system can also be cured via a radiation type cure (UV, e-beam, infrared, microwave, x-ray, or gamma radiation.

In each of the adhesive systems described herein, the programmable linker (PL) and diene trap (DT) combination are the key aspects of the invention. Without being bound by theory, the PL and DT system can be incorporated into a variety of basic one or two part polymer systems that currently are used in crosslinking systems. Examples are well known by those skilled in the art and include, but are not limited to polyurethanes, polyureas, epoxys, silicones, oximes, acrylics, acrylic copolymers, modified olefins, rubbers (synthetic and natural), or polysulfides.

The present invention will be described in more detail below through examples, but these examples are not intended to limit the present disclosure.

### EXAMPLES

Example formulations are found below. The same polymer base was used in all of these experiments: hydroxy terminated polybutadiene (HTPB). This multifunctional polymer can be substituted for a different polyol with pendant or incorporated diene traps. Alternatively, the diene trap can be a small molecule additive within the matrix. Each of these prototype formulations uses different dienes (furan, fulvene, and anthracene) as the counterpart to the maleimide dienophile. By using the different Diels-Alder pairs, differences in the heat resistance and ultimate debonding temperature of the system can be obtained.

### Example 1

### Two Part B Stage Film (Furan As Diene)—Experimental

A magnetic stir bar was added with a diisocyanate (2.4 eq), such as 1,6 hexamethylene diisocyanate (HMDI), methylene diphenyl diisocyanate (MDI), isophorone diisocyanate (IPDI) or combinations thereof, and allowed to cool for 10 minutes. Simultaneously, N-(4-Hydroxyphenyl)maleimide (2 eq) was dissolved in THF in a separate vial along with dibutyltin dilaurate as catalyst (0.019 eq). The THF solution was added to the round bottom flask and removed from ice. HTPB prepolymer (1 eq) was added to the flask and then stirred overnight at 50° C. The following day reaction progress was Structure confirmed via 1H NMR: δ (ppm) by new peaks at δ (ppm) 7.10, 6.85, and 6.8. After confirmation of incorporation to the polymer, Furfuryl alcohol (2 eq) was added to the flask and returned to heat overnight at 50° C. A sample was taken to confirm the DA adduct had formed via 1H NMR. Solvent was removed via rotary evaporation and resulting weight percent calculated. Additional diisocyanate (9.6 eq) was mixed into the polymer and partially cured before performing drawdowns with a RDS #50 bar to create a partially crosslinked (B-stage) film on a release liner.

### Example 2 Two Part B Stage Film (Fulvene As Diene)—Experimental

A magnetic stir bar is added with a diisocyanate (2.4 eq), such as 1,6 hexamethylene diisocyanate (HMDI), methylene diphenyl diisocyanate (MDI), isophorone diisocyanate (IPDI) or combinations thereof, and allowed to cool for 10 minutes. Simultaneously, N-(4-Hydroxyphenyl)maleimide (2 eq) is dissolved in THF in a separate vial along with dibutyltin dilaurate as catalyst (0.019 eq). The THF solution is added to the round bottom flask and removed from ice. HTPB prepolymer (1 eq) is added to the flask and then stirred overnight at 50° C. The following day reaction progress was Structure confirmed via 1H NMR: δ (ppm) by new peaks at δ (ppm) 7.10, 6.85, and 6.8. After confirmation of incorporation into the polymer, butanol fulvene (2 eq) is added to the flask and returned to heat overnight at 100-130° C. Additional diisocyanate (9.6 eq) is mixed into the polymer and partially cured before performing drawdowns with a RDS #50 bar to create a partially crosslinked (B-stage) film on a release liner.

### Example 3 Two Part B Stage Film (Anthracene As Diene)—Experimental

A magnetic stir bar is added with a diisocyanate (2.4 eq), such as 1,6 hexamethylene diisocyanate (HMDI), methylene diphenyl diisocyanate (MDI), isophorone diisocyanate (IPDI) or combinations thereof, and allowed to cool for 10 minutes. Simultaneously, N-(4-Hydroxyphenyl)maleimide (2 eq) is dissolved in THF in a separate vial along with dibutyltin dilaurate as catalyst (0.019 eq). The THF solution was added to the round bottom flask and removed from ice. HTPB prepolymer (1 eq) was added to the flask and then stirred overnight at 50° C. The following day reaction progress was Structure confirmed via 1H NMR: δ (ppm) by new peaks at δ (ppm) 7.10, 6.85, and 6.8. After confirmation of incorporation to the polymer, 9-methanol anthracene (2 eq) is added to the flask and returned to heat overnight at 100-130° C. Additional diisocyanate (9.6 eq) is mixed into the polymer and partially cured before performing drawdowns with a RDS #50 bar to create a partially crosslinked (B-stage) film on a release liner.

### Example 4 Formulation ‘A’ General Procedure

A 100 mL round bottom flask is loaded with a diisocyanate, such as 1,6 hexamethylene diisocyanate (HMDI), methylene diphenyl diisocyanate (MDI), isophorone diisocyanate (IPDI) or combinations thereof, and a magnetic stir bar and chilled over ice and brine for 10 minutes. In a separate vessel, a diene (butanol fulvene or 9-methanol anthracene) (diene-OH) and a drop of dibutyltin dilaurate (DBTDL) are combined and added into the reaction vessel dropwise while stirring. The reaction vessel is then removed from the ice and brine and allowed to stir at room temperature for 1 hour, adding minimal tetrahydrofuran (THF) to keep reagents dissolved. The amount of THF added overall through the reaction is not to exceed 1 mL THF for each gram of Hydroxyl-terminated polybutadiene (HTPB) added. HTPB is then added with additional THF. Once the contents were homogeneously mixed, a second addition of diene-OH was made. The mixture is then stirred for 2 hours. At this time, N-(4-Hydroxyphenyl)maleimide (PM) is added and the reaction is stirred until homogeneously mixed by visual inspection. Once done, the vessel is then capped with a rubber septum, secured with copper wire, and placed in an oil bath to stir overnight (temperature settings-for butanol fulvene @60-90° C.; for 9-methanol anthracene 100-130° C.).

### Example 5

### Formulation ‘A2’ General Procedure

A 100 mL round bottom flask is loaded with a diisocyanate, such as 1,6 hexamethylene diisocyanate (HMDI), methylene diphenyl diisocyanate (MDI), isophorone diisocyanate (IPDI) or combinations thereof, and a magnetic stir bar and chilled over ice and brine for 10 minutes. In a separate vessel, a diene (butanol fulvene or 9-methanol anthracene) (diene-OH), a drop of DBTDL, and THF (20% by volume of diene-OH) are combined and added into the reaction vessel dropwise. The reaction vessel is then removed from the ice and brine and allowed to stir at room temperature for 1 hour. A solution of HTPB and THF (in a ratio of 1 mL of THF for each gram of HTPB) is then added. Once the contents are homogeneously mixed, a second addition of diene-OH was made and stirred at room temperature for 2 hours. At this time, N-(4-Hydroxyphenyl)maleimide (PM) is added and stirred into the reaction until homogeneously mixed by visual inspection. The vessel is then capped with a rubber septa, secured with copper wire, and remains stirring in an oil bath overnight (temperature settings-for butanol fulvene @60-90° C.; for 9-methanol anthracene 100-130° C.).

### Example 6 Formulation ‘A3’ General Procedure

A 100 mL round bottom flask is loaded with a diisocyanate, such as 1,6 hexamethylene diisocyanate (HMDI), methylene diphenyl diisocyanate (MDI), isophorone diisocyanate (IPDI) or combinations thereof, and a magnetic stir bar and chilled over ice and brine for 10 minutes. In a separate vessel, a diene (butanol fulvene or 9-methanol anthracene) (diene-OH) and a drop of DBTDL are combined and added into the reaction vessel dropwise. The reaction vessel is then removed from the ice and brine and allowed to stir at room temperature for 1 hour. A solution of HTPB and THF (in a ratio of 1 mL of THF for each gram of HTPB) is then added. Once the contents were homogeneously mixed, a second addition of diene-OH is made and stirred at room temperature for 2 hours. At this time, N-(4-Hydroxyphenyl)maleimide (PM) is added and stirred into the reaction until homogeneously mixed by visual inspection. The vessel is then capped with a rubber septum, secured with copper wire, and remains stirring in an oil bath at overnight (temperature settings-for butanol fulvene @60-90° C.; for 9-methanol anthracene 100-130° C.).

### Example 7 Formulation ‘A4’ General Procedure

A 100 mL round bottom flask is loaded with a diisocyanate, such as 1,6 hexamethylene diisocyanate (HMDI), methylene diphenyl diisocyanate (MDI), isophorone diisocyanate (IPDI) or combinations thereof, and a magnetic stir bar and chilled over ice and brine for 10 minutes. In a separate vessel, a diene (butanol fulvene or 9-methanol anthracene) (diene-OH) and a drop of DBTDL are combined and added into the reaction vessel dropwise. The reaction vessel is then removed from the ice and brine and allowed to stir at room temperature for 1 hour. A solution of HTPB and THF (in a ratio of 1 mL of THF for each gram of HTPB) is then added. Once the contents were homogeneously mixed, N-(4-Hydroxyphenyl)maleimide (PM) is added and stirred into the reaction until homogeneously mixed by visual inspection. The vessel is then capped with a rubber septum, secured with copper wire, and remains stirring in an oil bath at overnight (temperature settings-for butanol fulvene @60-90° C.; for 9-methanol anthracene 100-130° C.).

### Example 8 Adhesive Testing of Defeatable Adhesive Formulations General Procedure for Testing Formulations

Formulation drawdowns are cut into 4 in×4 in coupons and applied to a 4 in×6 in sized 100% polyester knit fabric. The adhesive coupon is then tacked to the fabric through application of heat and pressure (typically 65° C. for 30 s) using a manual heat press. The release liner was then removed from the laminate, leaving the adhesive exposed and another layer of fabric was applied to the stack. This configuration is then bonded under various combinations of time, temperature, and pressure to create a fully bonded laminate.

These laminate structures are cut into 1-inch strips and evaluated using a t-peel methodology on a universal tensile testing machine to evaluate the peel strength. Samples with peel strength above 100N/m are then subjected to elevated temperatures (>130 C) to determine debonding behavior. Successful samples are too weak to measure using our equipment.

One skilled in the art will readily appreciate that the present disclosure is well adapted to carry out the objects and obtain the ends and advantages mentioned, as well as those inherent therein. The present disclosure is representative of embodiments, which are exemplary and are not intended as limitations on the scope of the present disclosure. Changes and other uses will occur to those skilled in the art which are encompassed within the spirit of the present disclosure as defined by the scope of the claims.

No admission is made that any reference, including any non-patent or patent document cited in this specification, constitutes prior art. It will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

1. A debondable adhesive formulation, comprising
(i) a multifunctional polymer having programmable linkages made from Diels-Alder adducts and
(ii) a concentration of diene traps, wherein:
the programmable linkages comprise one or more diene-dienophile pairs capable of forming the Diels-Alder adducts,
the diene traps are (i) latent alkenes or (ii) selected from functional groups that will react with the one or more dienes to create diene-diene trap adducts that remain stable until dissociated at a debondable temperature of the adhesive, wherein moles of the diene trap exceed moles of the one or more dienes,
the debondable adhesive formulation is capable of being applied as a coating,
the debondable adhesive formulation is capable of being extruded,
the debondable adhesive formulation has a bonding temperature between 30 degrees Celsius and 150 degrees Celsius,
the debondable temperature of the adhesive formulation is at or above 130 degrees Celsius, wherein when the debondable adhesive formulation is at or above the debondable temperature, at least a portion of one or both the programmable linkages and the diene-diene trap adducts disassociate and an adhesive bonding force is reduced, and
the adhesive formulation includes non-programmable linkages that do not disassociate at the debondable temperature.

2. The debondable adhesive formulation of claim 1, wherein the one or more diene-dienophile pairs are selected from furan-maleimide, anthracene-maleimide, and fulvene-maleimide, and combinations thereof.

3. The debondable adhesive formulation of claim 1, wherein the one or more diene-dienophile pairs comprises furan-maleimide, the bonding temperature ranges from 65-100° C., and the debondable temperature ranges from 110-160° C.

4. The debondable adhesive formulation of claim 1, wherein the one or more diene-dienophile pairs comprises fulvene-maleimide, the bonding temperature ranges from 75-110° C., and the debondable temperature ranges from 120-160° C.

5. The debondable adhesive formulation of claim 1, wherein the one or more diene-dienophile pairs comprises anthracene-maleimide, the bonding temperature ranges from 90-130° C., and the debondable temperature ranges from 130-160° C.

6. The debondable adhesive formulation of claim 1, wherein the multifunctional polymer comprises a functionality of 2.0 or greater for network forming capabilities.

7. The debondable adhesive formulation of claim 1, wherein the multifunctional polymer comprises an oligomeric or polymeric polyol.

8. The debondable adhesive formulation of claim 1, in the form of an adhesive film produced through coating or extrusion methods.

9. A laminate or composite structure made using the debondable adhesive formulation of claim 1, comprising synthetic or natural fibers, blends of synthetic or natural fibers, synthetic or natural fiber-based textiles, textiles comprised of synthetic or natural fibers, plastic films or sheets, molded plastic parts, paper, ceramics, glass, or metals, or any combination thereof.

10. The debondable adhesive formulation of claim 1, comprising one or more additives to improve flow, bonding, or other behavior.

11. The debondable adhesive formulation of claim 1, wherein a mole ratio of the dienophile to the diene is 0.10-0.75.

12. The debondable adhesive formulation of claim 1, wherein a mole ratio of the diene trap to the diene ranges from greater than 1 to 25.

13. The debondable adhesive formulation of claim 1, wherein a mole ratio of the programmable linkage to the non-programmable linkage ranges from 0.01-4, 0.1-1, or 0.5-0.9.

14. The debondable adhesive formulation of claim 1, wherein the debondable adhesive formulation is a B-stage thermoset.

15. A two-part adhesive formulation, comprising:
a first formulation comprising a first crosslinker having a reactive functionality of two or more and having incorporated programmable linkages made from Diels-Alder adducts; and
a second formulation comprising a second crosslinker having a reactive functionality of two or more and capable of reacting with the first crosslinker, and wherein one or both of the first and second formulations comprise a concentration of diene traps,
wherein the programmable linkages comprise one or more diene-dienophile pairs capable of forming the Diels-Alder adducts;
the diene traps are (i) latent alkenes or (ii) selected from functional groups that will react with the one or more dienes to create diene-diene trap adducts that remain stable until dissociated at a debondable temperature, wherein moles of the diene trap exceed moles of the one or more dienes;
after combination of the first and second formulations, the combined adhesive formulation has a bonding temperature between 30° C. and 150° C.;
the debondable temperature of the combined adhesive formulation is above 130° C., wherein when the combined adhesive formulation is at or above 130° C., at least a portion of one or both the programmable linkages and the diene-diene trap adducts disassociate and an adhesive bonding force is reduced; and
the combined adhesive formulation includes non-programmable linkages that do not disassociate at the debondable temperature.

16. The two-part adhesive formulation of claim 15, wherein the first crosslinker comprises a polyol having two or more reactive alcohol functionalities, the second crosslinker comprises a polyol or a diisocyanate, and the two-part adhesive formulation is a polyurethane adhesive formulation.

17. The two-part adhesive formulation of claim 15, wherein the first crosslinker comprises an isocyanate having a reactive functionality of two or more, and the first formulation further comprises a polyol crosslinker having two or more reactive alcohol functionalities.

18. The two-part adhesive formulation of claim 15, wherein the first crosslinker comprises an epoxy-based crosslinker and the second crosslinker comprises a polyol or polyamine having two or more reactive functionalities.

19. The two-part adhesive formulation of claim 15, wherein the first crosslinker comprises a polyol or polyamine having two or more reactive functionalities and the second crosslinker comprises an epoxy-based crosslinker having two or more reactive functionalities.

20. The two-part adhesive formulation of claim 15, wherein the first crosslinker comprises a silane-based crosslinker and the second crosslinker comprises a silane or silicone having two or more reactive functionalities.

21. A method of forming a debondable adhesive, the method comprising:
forming a multifunctional crosslinkable polymer including a concentration of dienes, dienophiles, and diene traps, wherein:
the diene and dienophile react to form a first Diels-Alder adduct;
the diene trap is (i) a latent alkene or (ii) selected from functional groups that will react with the diene to create diene-diene trap adducts that remain stable until dissociated at a debondable temperature of the adhesive;
moles of the diene trap exceed moles of the diene;
a presence of the diene-diene trap adduct is dominant at a bonding temperature of the adhesive;
a retro Diels-Alder reaction of both the first and the second Diels-Alder adduct is dominant at a debondable temperature of the adhesive and an adhesive bonding force is reduced;
the bonding temperature is between 30 degrees Celsius and 150 degrees Celsius;
the debondable temperature is a temperature at or above 150 degrees Celsius; and
the multifunctional crosslinkable polymer includes linkages that do not disassociate at the debondable temperature.
